(19) United States
(12) Patent Application Publication
(10) Pub. No.: US 2007/0075582 A1
(43) Pub. Date: Apr. 5, 2007

(54) Braking device for vehicle

(75) Inventors: Masanobu Nakayama, Saitama (JP); Yukimasa Nishimoto, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/528,469

(22) Filed: Sep. 28, 2006

(30) Foreign Application Priority Data
Sep. 30, 2005 (JP) 2005-288333

(51) Int. Cl. B60T 8/60

(52) U.S. Cl. 303/146

(57) ABSTRACT

To provide a braking device for a vehicle, which is capable of switching properly between single braking for one of front and rear wheels and combined braking with CBS according to the driving conditions of the vehicle, and of thereby achieving the balance between active vehicle controllability based on a driver's intention and braking performance. Brake systems respectively for the front and rear wheels are provided so that brake caliper assemblies respectively for the front and rear wheels can be operated independently of each other with brake operating sections exclusively for the brake caliper assemblies for the front and rear wheels, respectively. The brake system for the front wheel is provided with a hydraulic pressure modulator capable of feeding a braking force to the brake caliper assembly for the front wheel. When a rear wheel slip ratio exceeds a threshold value under rear brake operation, a controller activates the hydraulic pressure modulator for the front wheel to start braking the front wheel.

### CROSS-REFERENCE TO RELATED APPLICATIONS

This nonprovisional application claims priority under 35 U.S.C. §119(a) on Patent Application No. 2005-288333, filed in Japan on Sep. 30, 2005, the entirety of which is incorporated herein by reference.

### BACKGROUND OF THE INVENTION

1. Field of the Invention

The present invention relates to a braking device used in a vehicle such as a motorcycle.

2. Description of Background Art

A braking device for a motorcycle is known in the background art. In particular, a known braking device uses a brake system (a combined brake system, which will hereinafter be referred to simply as a “CBS”), which includes front and rear brake operating sections respectively for front and rear wheels, and front and rear wheel braking sections (e.g., brake caliper assemblies) respectively for the front and rear wheels. The brake operating section for one of the front and rear wheels is combined with the wheel braking section for the other wheel to cooperate therewith (see Japanese Patent Application No. Hei 07-196068 and Japanese Patent Application No. Hei 04-138989, for example).

A braking device using a CBS is designed to distribute a brake master cylinder pressure for one of the front and rear brake operating sections between the front and rear wheel braking sections, and to use a control valve to adjust a distribution ratio between the front and rear of a vehicle, or the like. Moreover, this type of braking device is also contrived so that, when the brake operating section for one of the front and rear wheels is operated, the device cuts off the supply of hydraulic pressure to the wheel braking section for the other wheel, and changes the distribution ratio according to a brake internal pressure, instead of constantly distributing a hydraulic pressure between the front and rear wheel braking sections at a fixed ratio.

However, the braking device according to the background art is designed to determine whether activation of the CBS is to be restricted or released according to a brake internal pressure, regardless of a quality of ground contact conditions, or the like. Thus, for example, when driving for recreational purposes, such as sports driving, it is conceivable that the use of the brake to attempt to exert a braking force on the rear wheel alone can cause a situation where activation of the CBS is not restricted, and that the braking force acts on the front wheel.

### SUMMARY OF THE INVENTION

To this end, an object of the present invention is to provide a braking device for a vehicle, which is capable of switching properly between single braking for one of front and rear wheels and CBS-based combined braking according to the condition of a road surface.

As means for solving the above problem, a first aspect of the present invention is directed to a braking device for a vehicle, including: brake operating sections (e.g., brake operating sections 2 in an embodiment to be described later) respectively for front and rear wheels; wheel braking sections (e.g., brake caliper assemblies 4 in the embodiment to be described later) respectively for the front and rear wheels, each of the wheel braking sections applying a braking force to the corresponding one of the wheels in accordance with an input from each of the brake operating sections; and combined braking means (e.g., a controller 20 in the embodiment to be described later) for, according to an input from the brake operating section for one of the wheels, activating the wheel braking section for the other wheel thereof. The braking device includes slip detecting means (e.g., a wheel speed sensor 31 or the controller 20 in the embodiments to be described later) for detecting a state in which each of the wheels slip. When the slip detecting means, during the application of a brake to one of the wheels, detects that one wheel is in a predetermined slipped state, the combined braking means starts combined activation of the wheel braking section for the other wheel.

In the first aspect of the present invention, until the slip detecting means detects that one wheel is in the predetermined slipped state, the combined braking means does not start the combined activation of the wheel braking section for the other wheel. Because of this, the corresponding one of the wheels is independently subjected to braking according to the operation of the brake operating section.

According to a second aspect of the present invention, an antilock brake system controls an increase or decrease in a braking force according to the slipped state of each of the wheels. A slip detecting section for the antilock brake system is used as the slip detecting means, and when the antilock brake system is activated for one of the wheels, the combined braking means starts the combined activation of the wheel braking section for the other wheel.

In the second aspect of the present invention, the slip detecting means for the antilock brake system is also used as the slip detecting means under combined control. Moreover, when one wheel enters the predetermined slipped state, the activation of the antilock brake system and combined braking are started substantially at the same time.

According to a third aspect of the present invention, the braking device includes: an input detecting sensor (e.g., an input pressure sensor 28 d in the embodiment to be described later) which electrically detects an input from the brake operating section; a braking force generator (e.g., a hydraulic pressure modulator 6 in the embodiment to be described later), which generates a braking force according to a control command, and which feeds the braking force to the wheel braking section; and control means (e.g., the controller 20 in the embodiment to be described later), which receives a vehicle status detection signal including a detection signal from the input detecting sensor, and which issues the control command to the braking force generator. The braking force generator is used to perform combined control at least on the wheel braking section for the other wheel.

In the third aspect of the present invention, because the braking force generator is used to perform the combined control on the wheel braking section for the other wheel, a braking reaction force developed during the combined braking is not transmitted to the brake operating section.

According to a fourth aspect of the present invention, the braking device includes road surface resistance estimating means for estimating a road surface resistance, and the combined braking means has varying braking characteristics according to an estimation result determined by the road surface resistance estimating means so that a braking force is smaller as the road surface resistance is lower.

In the third aspect of the present inventioin, the braking force for the combined braking is adjusted so that the braking force is smaller as the road surface resistance is lower.

According to a fifth aspect of the present invention, the braking device includes: hydraulic pressure generating means constituted by the braking force generator; a brake master cylinder (e.g., a brake master cylinder 3 in the embodiment to be described later) which generates a hydraulic pressure according to an operation variable of the brake operating section; a brake caliper assembly (e.g., the brake caliper assembly 4 in the embodiment to be described later) which applies a braking force to the wheel according to the supplied hydraulic pressure; and a passage switching valve (e.g., first and third solenoid on-off valves V1 and V3 in the embodiment to be described later) which selectively connects the brake caliper assembly to the brake master cylinder and the hydraulic pressure generator. During normal braking, the hydraulic pressure in the brake master cylinder is supplied to the brake caliper assembly, and during braking by the combined braking means, the hydraulic pressure in the hydraulic pressure generator is supplied to the brake caliper assembly for the other wheel.

In the fifth aspect of the present invention, the hydraulic pressure generator provides the supply of the hydraulic pressure only under conditions where the combined braking means performs the braking, and the hydraulic pressure generator can be set to be in an inactive state during the normal braking.

According to the first aspect of the present invention, until slip detecting means detects that one wheel is in a predetermined slipped state, a combined braking means does not perform combined braking for the other wheel. Thus, when the wheels are in a good ground contact condition, the corresponding one of the wheels can be independently subjected to braking through the operation of the brake operating section for one of the wheels. For this reason, the present invention enables a driver to use single braking to control a vehicle well, while maintaining braking performance during hard braking or in situations where the conditions of the road surface are poor.

According to the second aspect of the present invention, the slip detecting means for an antilock brake system is also used as the slip detecting means for the combined braking. Thereby, the number of components can be reduced. Moreover, when one of the front and rear wheels enters the predetermined slipped state during the application of a brake to one wheel, the activation of the antilock brake system and that of the combined braking are started substantially at the same time. Hence, more effective braking on the vehicle is made possible.

According to third aspect of the present invention, at the time of the combined braking, the braking force generator, which is not mechanically combined with the brake system receiving the input from the brake operating section, feeds the braking force to the wheel braking section for the other wheel. Thus, a reaction force, which is developed immediately after the combined braking starts, does not act on the brake operating section. This results in an improvement in a driver's impression on brake operation.

According to the fourth aspect of the present invention, the braking characteristics at the time of the combined braking can be changed according to the road surface resistance during driving. Thereby, it is made possible to always achieve effective braking according to the conditions of the road surface.

According to fifth aspect of the present inventioin, the hydraulic pressure generator can be set to be in an inactive state during the normal braking. Thus, it is made possible to reduce energy consumption stemming from the activation of the hydraulic pressure generator.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a circuit diagram of a braking device according to one embodiment of the present invention;

FIG. 2 is a circuit diagram of the braking device according to the embodiment of the present invention;

FIG. 3 is a flowchart showing the flow of control at the time when the braking device according to the embodiment of the present invention performs braking;

FIG. 4 is a control map used in the braking device according to the embodiment of the present invention;

FIG. 5 is another control map used in the braking device according to the embodiment of the present invention; and

FIG. 6 is a flowchart showing a process for determining the condition of a road surface, which is executed by a braking device according to another embodiment of the present invention.

### DETAILED DESCRIPTION OF THE PREFERRED EMBODIMENTS

An embodiment of the present invention will now be described with reference to the accompanying drawings. The same reference numerals will be used to identify the same or similar elements throughout the several views.

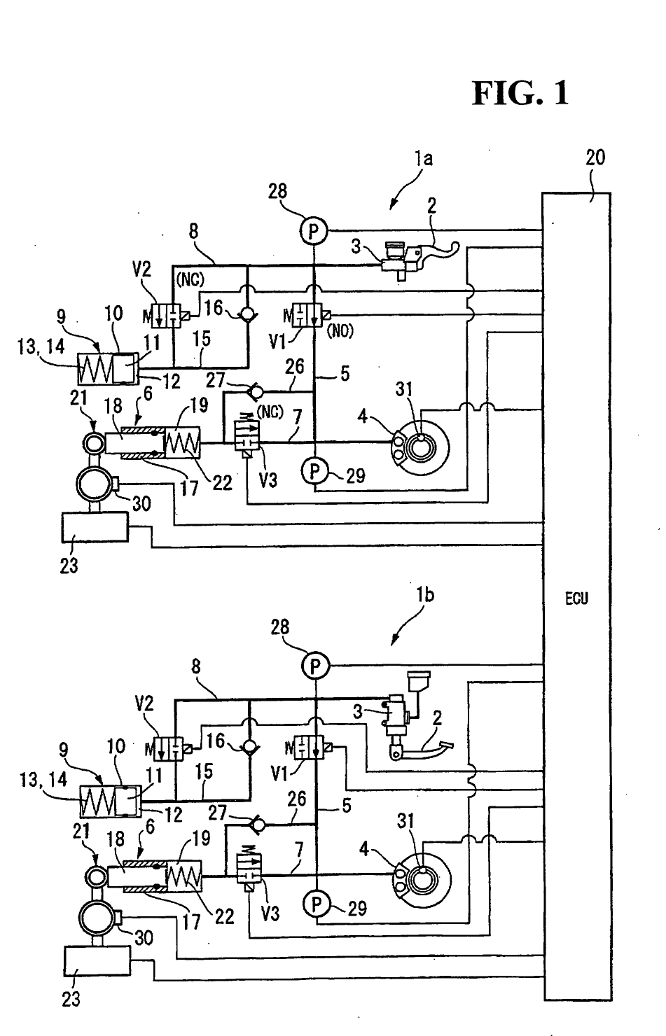

FIG. 1 shows a hydraulic circuit diagram of a braking device for a vehicle according to a first embodiment of the present invention. This embodiment is the braking device according to the present invention as applied to a motorcycle. The braking device includes front and rear brake circuits 1a and 1b, which are independent of each other, and each of which is subject to control by a controller (ECU) 20.

In a case of this braking device, the front and rear brake circuits 1a and 1b are configured to respectively use a brake lever and a brake pedal, which are brake operating sections 2 and 2, for their respective brake operations. Except for this respect, the basic configuration of the front brake circuit 1a is substantially identical to that of the rear brake circuit 1b. For this reason, the detailed descriptions will hereinbelow be given only for the rear brake circuit 1b. As for the front brake circuit 1a, the identical parts thereof as those of the rear brake circuit 1b are designated by the same reference numerals, and the repeated descriptions of the identical parts are omitted.

The braking device uses a so-called bi-wire system for both of the front and rear wheels. The braking device is designed to electrically detect an operation variable of the brake operating section 2 such as the brake pedal. Thereafter, the braking device uses a hydraulic pressure to apply a braking force to each of the wheels. The hydraulic pressure is generated by a hydraulic pressure modulator 6, which is a hydraulic pressure generator (a braking force generator), on the basis of the detection value.

The braking device performs the front wheel braking independently of the rear wheel braking under normal brake activation. Meanwhile, the braking device is also designed to combine front wheel braking with rear wheel braking when given conditions are met under rear brake operation.

Furthermore, the braking device uses a brake system (an antilock brake system, which will hereinafter be referred to simply as an “ABS”), which monitors the slipped state of the wheels under brake operation, and which increases or reduces a hydraulic pressure to perform proper control on a wheel slip ratio.

The brake circuit 1b includes a brake master cylinder 3 which generates a hydraulic pressure according to the operation variable of the brake operating section 2. A brake caliper assembly 4 is a wheel braking section corresponding to the brake master cylinder 3. A main brake passageway 5 connects the brake master cylinder 3 to the brake caliper assembly 4. The hydraulic pressure modulator 6 is joined in the main brake passageway 5 by way of a supply and exhaust passageway 7.

The main brake passageway 5 has a first solenoid on-off valve V1 of normally open (NO) type interposed therein toward the brake master cylinder 3 away from the junction of the main brake passageway 5 with the supply and exhaust passageway 7. The first solenoid on-off valve V1 provides or interrupts communication between the brake master cylinder 3 and the brake caliper assembly 4. The main brake passageway 5 has a connection to a branch passageway 8, which is disposed toward the brake master cylinder 3 away from the first solenoid on-off valve V1. The branch passageway 8 has a connection to a fluid loss simulator 9 via a second solenoid on-off valve V2 of normally closed (NC) type. The fluid loss simulator 9 exerts a pseudo hydraulic reaction force on the brake master cylinder 3 according to the operation variable of the brake operating section 2, when the first solenoid on-off valve V1 is closed to close the main brake passageway 5. At the time of the application of the reaction force, the second solenoid on-off valve V2 is opened to open the branch passageway 8, and thereby provides a connection between the brake master cylinder 3 and the fluid loss simulator 9.

The fluid loss simulator 9 includes a cylinder 10. A piston 11 is accommodated in the cylinder 10 in such a manner that the piston 11 can move in and out of the cylinder 10. A fluid chamber 12 is formed between the cylinder 10 and the piston 11 so as to accommodate a hydraulic operating fluid flowing into the fluid loss simulator 9 from the direction of the brake master cylinder 3. A coil spring 13 and a resin spring 14 each with characteristics different from those of each other are arranged in series behind the piston 11 so as to exert a reaction force on the brake operating section 2 via the piston 11.

The branch passageway 8 is also provided with a bypass passageway 15 which bypasses the second solenoid on-off valve V2. The bypass passageway 15 is provided with a check valve 16 which admits the operating fluid flowing from the fluid loss simulator 9 toward the brake master cylinder 3.

The hydraulic pressure modulator 6 includes a cylinder 17. A piston 18 is provided in the cylinder 17. A hydraulic pressure chamber 19 is formed between the cylinder 17 and the piston 18. A cam mechanism 21 presses the piston 18 toward the hydraulic pressure chamber 19. A return spring 22 constantly presses the piston 18 toward the cam mechanism 21. An electric motor 23 actuates the cam mechanism 21. The hydraulic pressure chamber 19 is connected in communication with the supply and exhaust passageway 7. The hydraulic pressure modulator 6 adjusts the position of the piston 18 by use of the cam mechanism 21 driven by the electric motor 23 and a reaction force developed by the return spring 22. Thereby, the volumetric capacity of the hydraulic pressure chamber 19 is changed. The change of the volumetric capacity of the hydraulic pressure chamber 19 causes an increase or decrease in a braking pressure of the brake caliper assembly 4 through the supply and exhaust passageway 7.

The electric motor 23 is subject to PWM (pulse-width modulation) control, which involves controlling the current value determined by an input duty ratio, thereby adjusting the angle of revolution of the electric motor 23. The electric motor 23 controls the cam mechanism 21 which manipulates a pressure in the hydraulic pressure chamber 19. Consequently, the electric motor 23 is controlled as mentioned above to effect precise control of an increase or decrease in the pressure in the hydraulic pressure chamber 19.

Moreover, the supply and exhaust passageway 7 has a third solenoid on-off valve V3 of normally closed (NC) type interposed therein, and is provided with a bypass passageway 26 which bypasses the third solenoid on-off valve V3. The bypass passageway 26 is provided with a check valve 27 which admits the operating fluid flowing from the hydraulic pressure modulator 6 toward the brake caliper assembly 4. The third solenoid on-off valve V3 is opened or closed in conjunction with the first and second solenoid on-off valves V1 and V2 under control of the controller 20. Particularly, the first and third solenoid on-off valves V1 and V3 function as passage switching valves which selectively connect the brake caliper assembly 4 to the brake master cylinder 3 and the hydraulic pressure modulator 6, respectively.

In the brake circuit 1b, an input pressure sensor 28 (an input detecting sensor) and an output pressure sensor 29 are provided in a passageway toward the brake master cylinder 3 (on the input side) and in a passageway toward the brake caliper assembly 4 (on the output side), respectively, with the first solenoid on-off valve V1 interposed in between. In addition, an unillustrated cam shaft of the cam mechanism 21 is provided with an angle sensor 30 for use in feedback of information on an angle. A wheel speed sensor 31, which detects a wheel speed, is provided in close proximity to the wheel. The controller 20 receives detection signals, as input signals, from the pressure sensors 28 and 29, the angle sensor 30 and the wheel speed sensor 31.

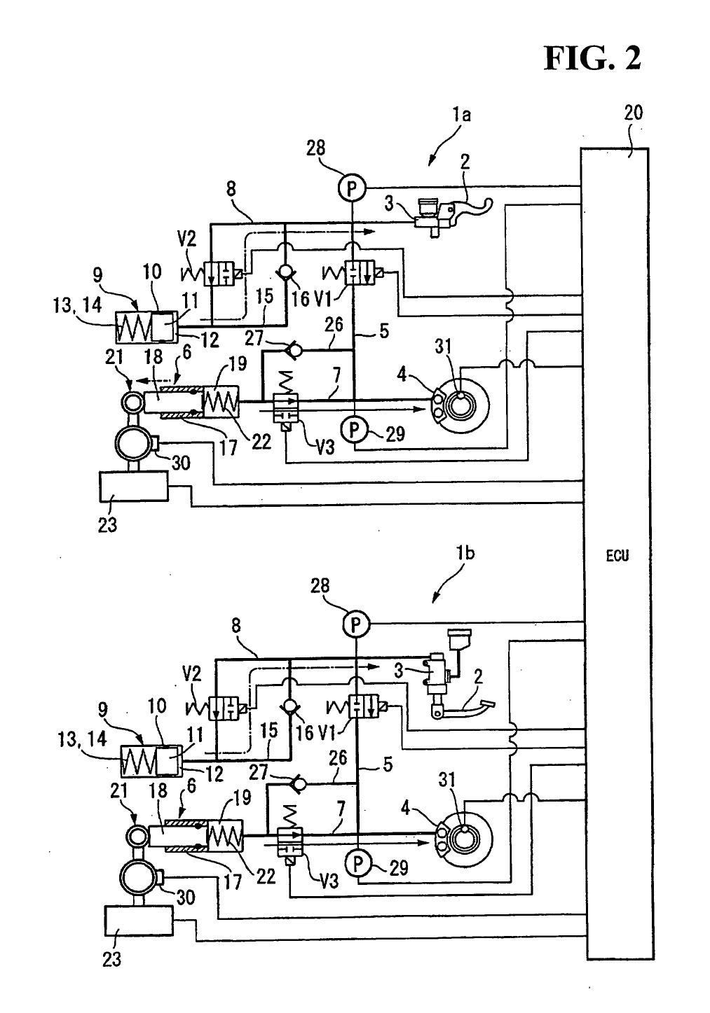

When the vehicle is at a stop (vehicle speed=0), the braking device is in a state where the second and third solenoid on-off valves V2 and V3 are closed, and the first solenoid on-off valve V1 is open, as shown in FIG. 1. When the vehicle starts to move (vehicle speed>0), the first solenoid on-off valve V1 is closed, and the second and third solenoid on-off valves V2 and V3 are opened under control of the controller 20. Thereby, the brakes using the bi-wire system as mentioned above enter a standby state (see FIG. 2).

Specifically, in this state, the closing of the first solenoid on-off valve V1 causes the main brake passageway 5 to be disconnected from the brake master cylinder 3. Concurrently, the opening of the second solenoid on-off valve V2 causes the brake master cylinder 3 to be connected to the fluid loss simulator 9. Furthermore, the opening of the third solenoid on-off valve V3 causes the hydraulic pressure modulator 6 to be connected to the brake caliper assembly 4.

When a rider operates the brake operating section 2 in the standby state, this operation causes the brake master cylinder 3 to generate a hydraulic pressure, which is then introduced directly into the fluid loss simulator 9, and which is concurrently detected by the input pressure sensor 28. When this occurs, the controller 20 issues an activation command, which is based on a detection signal from the input pressure sensor 28, to the hydraulic pressure modulator 6. The command causes the hydraulic pressure modulator 6 to supply the hydraulic pressure to the corresponding brake caliper assembly 4 according to the brake operation.

Note that the braking device is configured so that the first solenoid on-off valve V1 is normally open, and that the second and third solenoid on-off valves V2 and V3 are normally closed. Hence, the brake master cylinder 3 and the brake caliper assembly 4 are connected to each other by way of the main brake passageway 5 when an ignition is off, when there is failure in an electric system, or in other situations. As a result, it is made possible to transmit an operating physical force on the brake operating section 2 directly to the brake caliper assembly 4.

The foregoing is the descriptions of the basic brake activation under normal braking. On the other hand, the ABS is activated when the wheel slip ratio exceeds a predetermined value during the brake activation. Descriptions will now be given for the ABS in this braking device.

To determine the slip ratio of each of the wheels, for example, the controller 20, first determines an estimated vehicle speed based on a detection signal from the wheel speed sensor 31 for each of the front and rear wheels, then converts the estimated vehicle speed into a wheel speed. Thereafter, the controller 20 determines the slip ratio of the wheels by performing a calculation based on a difference between the resultant wheel speed and an actual wheel speed. When the wheel slip ratio exceeds the preset threshold value of the slip ratio, the controller 20 determines the occurrence of wheel slip, and starts to perform ABS control on the hydraulic pressure modulator 6. The hydraulic pressure modulator 6 activates the electric motor 23 to repeatedly reduce, hold and again increase a hydraulic pressure. Thereby, the hydraulic pressure on the brake caliper assembly 4 is controlled so that the wheel slip ratio is maintained equal to, or less than, the threshold value.

Incidentally, the first solenoid on-off valve V1 is closed during ABS activation. Thus, the first solenoid on-off valve V1 interrupts communication between the brake master cylinder 3 and the hydraulic pressure modulator 6, so that a hydraulic reaction force due to the ABS control does not affect the brake operating section 2.

Descriptions will now be given for a system (a CBS) of the braking device for combined braking for the front wheel at the time when the brake is operated for the rear wheel.

In this system, the controller 20 includes a combined braking device. When the controller 20 determines that the rear wheel is in a predetermined slipped state (a state where the slip ratio exceeds the threshold value), the controller 20 activates the hydraulic pressure modulator 6 of the brake circuit 1a for the front wheel to thereby exert a braking force on the front wheel. Specifically, the controller 20 determines the predetermined slipped state of the rear wheel according to whether or not the ABS activation occurs. When the controller 20 determines the occurrence of the ABS activation, the controller 20 activates the hydraulic pressure modulator 6 for the front wheel so that the hydraulic pressure modulator 6 supplies a hydraulic pressure to the brake caliper assembly 4 for the front wheel.

Under this combined braking, the hydraulic pressure generated by the hydraulic pressure modulator 6 is controlled to have such a value obtained in consideration of: an alienation width between a brake master cylinder pressure for the rear wheel at the time when the ABS starts operating and the brake master cylinder pressure after the point where the ABS starts operating; and the vehicle speed at the time of the braking.

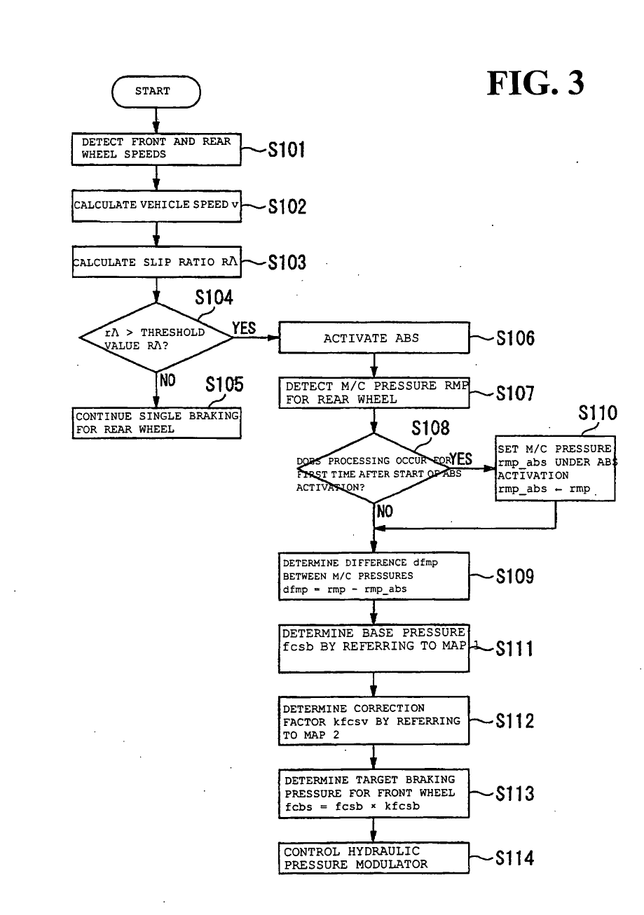

With reference to a flowchart of FIG. 3, descriptions will be given below for a specific example of control under the rear brake operation.

First, at step S101, the wheel speed sensors 31 detect front and rear wheel speeds, respectively. At steps S102 and S103, calculations are made to determine a vehicle speed v and a rear wheel slip ratio rλ. Thereafter, at step S104, a determination is made as to whether or not the detected slip ratio rλ exceeds a threshold value Rλ. When the slip ratio rλ is equal to, or less than, the threshold value Rλ, the control proceeds to step S105, and continues with single braking for the rear wheel.

On the other hand, when a determination is made at step S104 that the slip ratio rλ exceeds the threshold value Rλ, the control proceeds to step S106, at which the ABS activation takes place. At next step S107, the input pressure sensor 28 detects a brake master cylinder pressure nnp for the rear wheel. At subsequent step S108, a determination is made as to whether or not processing occurs immediately after the start of the ABS activation (the processing occurs for the first time after the start of the ABS activation). When the processing occurs for a second time or later, the control proceeds to step S109. When a determination is made at step S108 that the processing occurs immediately after the start of the ABS activation, the control proceeds to step S110. At step S110, the brake master cylinder pressure rmp detected at step S107 is stored as a brake master cylinder pressure rmp_abs under the ABS activation. After that, the control proceeds to step S109.

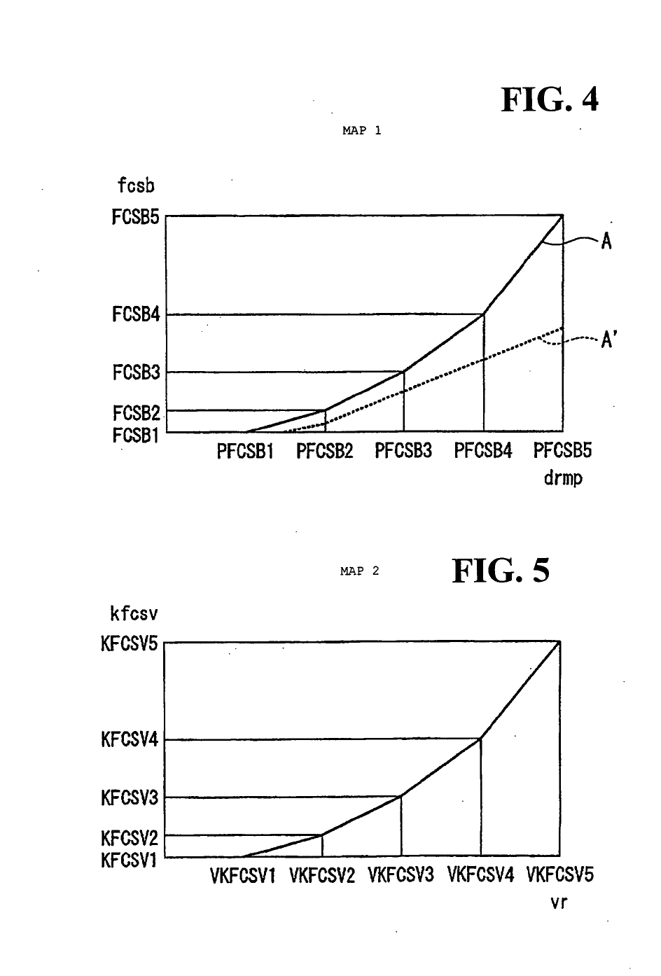

At step S109, a calculation is made to determine a difference dfmp between the current brake master cylinder pressure rmp and the brake master cylinder pressure rmp_abs under the ABS activation. At subsequent step S111, a front wheel braking base pressure fcsb corresponding to the difference dfmp is determined by referring to a map 1 shown in FIG. 4 (i.e., a plot of correspondence between dfmp and fcsb shown by the solid line A in FIG. 4). Next, at step S112, a correction factor kfcsv corresponding to the current vehicle speed v is determined in a similar manner by referring to a map 2 shown in FIG. 5.

Thereafter, at step S113, a target braking pressure fcbs for the front wheel is determined by multiplying the front wheel braking base pressure fcsb by the correction factor kfcsv. At subsequent step S114, the hydraulic pressure modulator 6 is controlled so as to generate the target braking pressure fcbs.

In this braking device, because the control is performed in the manner as described above, the braking device performs neither the ABS activation for the rear wheel nor combined braking for the front wheel, provided that the rear wheel slip ratio rλ does not exceed the threshold value Rλ when the brake operating section 2 for the rear wheel is operated. Thus, under this condition, the hydraulic pressure modulator 6 simply supplies a hydraulic pressure to the brake caliper assembly 4 for the rear wheel according to the operation variable of the brake operating section 2 for the rear wheel.

Hence, for example, even when the rider uses the rear brake to actively control the behavior of the vehicle during cornering, the combined braking for the front wheel does not work against a rider's will as long as the rear wheel slip ratio does not exceed the threshold value.

Meanwhile, in a situation where the rear wheel slip ratio rλ exceeds the threshold value Rλ under the rear brake operation, the ABS activation and the combined braking for the front wheel are simultaneously started. Thereby, rear wheel is properly prevented from slipping, and a shift to more efficient braking is achieved. For this reason, the braking device can improve braking performance during hard braking or in other situations without inhibiting the rear brake from delivering vehicle controllability thereof.

Moreover, the braking device according to the embodiment also has an advantage that the manufacturing costs can be reduced due to reduction of the number of components. This is because the system for the combined braking for the front wheel has components for the ABS, such as the wheel speed sensor 31 and the hydraulic pressure modulator 6, for common use.

Furthermore, the braking device does not impair a driver's impression on brake operation, because the bi-wire system is used as a basic brake operating system so that, during the combined braking for the front wheel, a braking reaction force from the front wheel does not act directly on the brake operating section 2 for the rear wheel.

Incidentally, in the case of the embodiment, the front brake can be always used for single braking. The braking device may also be designed so that the rear wheel is subjected to combined braking when the ABS is activated for the front wheel under front brake operation. In this case, the combined braking for the rear wheel takes place in the similar manner as the combined braking for the front wheel.

Moreover, in the above embodiment, at step S111, the map 1 is always used alone for reference to determine the front wheel braking base pressure fcsb. The braking device, however, may be designed to switch between a high μ road map and a low μ road map according to the resistance of a road surface during driving.

In this case, the maps may be prepared and used as follows. For example, the map 1 (i.e., the high μ road map) and the low μ road map are prepared. In the map 1, the level of the base pressure fcsb is generally high as shown by the solid line A in FIG. 4, and in the low μ road map, the level of the base pressure fcsb is generally low as shown by the broken line B in FIG. 4. The map 1 is used when the controller 20 determines that the road surface is in a high μ road state based on a detection signal from the wheel speed sensor 31 or the like. The low μ road map is used when the controller 20 determines that the road surface is in a low μ road state.

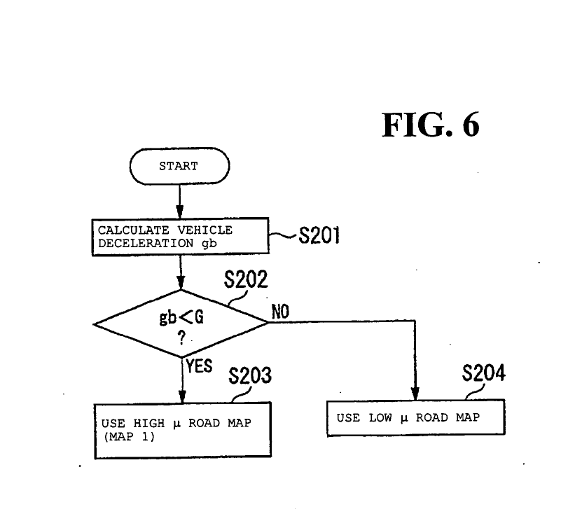

In this case, specific control is performed as shown in a flowchart of FIG. 6, for example. Descriptions will be given below for processing shown in FIG. 6. Incidentally, this processing is performed between steps S109 and S111 of the flowchart of FIG. 3.

First, at step S201, a vehicle deceleration gb (i.e., the amount of change in the vehicle speed v per unit time) during braking is determined on the basis of a detection signal from the wheel speed sensor 31. At subsequent step S202, a determination is made as to whether or not the detected vehicle deceleration gb is less than a threshold value G. When the vehicle deceleration gb is less than the threshold value G, the control proceeds to step S203, at which the high μ road map (the map 1) is selected. When the vehicle deceleration gb exceeds the threshold value G, the control proceeds to step S204, at which the low μ road map is selected.

In the case of a second embodiment shown in FIG. 6, braking characteristics (hydraulic pressure characteristics) during the combined braking for the front wheel are varied depending on the resistance of the road surface being high or low. Accordingly, effective combined braking can always be achieved according to the conditions of the road surface.

In addition, during the normal driving of the vehicle, the braking device described above closes the first solenoid on-off valve V1, and opens the second and third solenoid on-off valves V2 and V3 as shown in FIG. 2. Thereby, the bi-wire system is used (by disconnecting the brake master cylinder 3 from the brake caliper assembly 4) for braking. As opposed to the foregoing, during the normal driving, the braking device may open the first solenoid on-off valve V1, and close the second and third solenoid on-off valves V2 and V3 as shown in FIG. 1 so as to exert a pressure in the brake master cylinder 3 directly on the brake caliper assembly 4 according to the operation of the brake operating section 2.

In this case, during the combined braking, the bi-wire system is used to activate only the brake system for the wheel to be subjected to the combined braking. For example, when the rear wheel slip ratio exceeds the threshold value during the rear brake operation, the first solenoid on-off valve V1 of the front brake circuit is closed, and the second and third solenoid on-off valves V2 and V3 are opened. In this condition, the hydraulic pressure modulator 6 is activated to exert a braking force on the front brake caliper assembly 4.

The braking device according to a third embodiment can achieve basically the similar effect as the braking device according to the first embodiment previously mentioned. At the time of normal braking, the hydraulic pressure modulator need not be activated, and the corresponding amount of reduction in power consumption is made possible. This is because only the brake system for the wheel to be subjected to the combined braking (the wheel to be subjected to follow-up braking) during the combined braking is activated with the bi-wire system.

Moreover, the braking device according to the third embodiment does not need currents for holding the solenoid on-off valves V1 to V3 during normal braking or when braking is not activated. Thus, the corresponding amount of further reduction in power consumption is made possible. This is because the normally-open type valve is used as the first solenoid on-off valve V1, and because the normally-closed type valves are used as the second and third solenoid on-off valves V2 and V3.

The present invention is not limited to the above embodiments, and various design changes may be made to the invention without departing from the spirit and scope of the invention. For example, the descriptions have been given above for the embodiment as applied to the motorcycle using the bi-wire system and the ABS. However, the present invention may also be applied to the motorcycle which does not use the bi-wire system or the ABS. Moreover, the descriptions have been given above for the braking device which starts the combined braking for the front wheel when the rear wheel enters the predetermined slipped state during the rear brake operation. Meanwhile, the braking device may start the combined braking for the rear wheel when the front wheel enters the predetermined slipped state during the front brake operation, as opposed to the foregoing.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A braking device for a vehicle, the vehicle including brake operating sections respectively for front and rear wheels; wheel braking sections respectively for the front and rear wheels, each of the wheel braking sections applying a braking force to the corresponding one of the wheels according to an input from the brake operating section; and a combined braking device that activates the wheel braking section for the other wheel according to an input from the brake operating section for one of the wheels, said braking device for a vehicle comprising:
a slip detector that detects a state in which each of the wheels slips,
wherein, when the slip detector detects that one wheel is in a predetermined slipped state during application of a brake to the wheel, the combined braking device starts combined activation of the wheel braking section for the other wheel.

2. The braking device for a vehicle according to claim 1, further comprising an antilock brake system which controls an increase or decrease in a braking force according to the slipped state of each of the wheels, wherein:
a slip detecting section for the antilock brake system is used as the slip detector; and
when the antilock brake system is activated, the combined braking device starts the combined activation of the wheel braking section for the other wheel.

3. The braking device for a vehicle according to claim 1, further comprising:
an input detecting sensor which electrically detects an operation input from the brake operating section;
a braking force generator which generates a braking force according to a control command, and which feeds the braking force to the wheel braking section; and
a control that receives a vehicle state detection signal including a detection signal from the input detecting sensor, and which issues the control command to the braking force generator,
wherein the braking force generator is used to perform combined control at least on the wheel braking section for the other wheel.

4. The braking device for a vehicle according to claim 2, further comprising:
an input detecting sensor which electrically detects an operation input from the brake operating section;
a braking force generator which generates a braking force according to a control command, and which feeds the braking force to the wheel braking section; and
a control that receives a vehicle state detection signal including a detection signal from the input detecting sensor, and which issues the control command to the braking force generator,
wherein the braking force generator is used to perform combined control at least on the wheel braking section for the other wheel.

5. The braking device for a vehicle according to claim 1, further comprising a road surface resistance estimator that estimates a road surface resistance, wherein the combined braking device has varying braking characteristics according to an estimation result determined by the road surface resistance estimator, so that a braking force is smaller as the road surface resistance is lower.

6. The braking device for a vehicle according to claim 2, further comprising a road surface resistance estimator that estimates a road surface resistance, wherein the combined braking device has varying braking characteristics according to an estimation result determined by the road surface resistance estimator, so that a braking force is smaller as the road surface resistance is lower.

7. The braking device for a vehicle according to claim 3, further comprising:
a hydraulic pressure device constituted by the braking force generator;
a brake master cylinder which generates a hydraulic pressure according to an operation variable of the brake operating section;
a brake caliper assembly which applies a braking force to the wheel according to the supplied hydraulic pressure; and
a passage switching valve which selectively connects the brake caliper assembly to the brake master cylinder and the hydraulic pressure generator,
wherein during normal braking, the hydraulic pressure in the brake master cylinder is supplied to the brake caliper assembly; and during braking by the combined braking device, the hydraulic pressure in the hydraulic pressure generator is supplied to the brake caliper assembly for the other wheel.

8. The braking device for a vehicle according to claim 4, further comprising:
a hydraulic pressure device constituted by the braking force generator,
a brake master cylinder which generates a hydraulic pressure according to an operation variable of the brake operating section;
a brake caliper assembly which applies a braking force to the wheel according to the supplied hydraulic pressure; and
a passage switching valve which selectively connects the brake caliper assembly to the brake master cylinder and the hydraulic pressure generator,
wherein during normal braking, the hydraulic pressure in the brake master cylinder is supplied to the brake caliper assembly; and during braking by the combined braking device, the hydraulic pressure in the hydraulic pressure generator is supplied to the brake caliper assembly for the other wheel.

9. A vehicle, comprising:
front and rear wheels;
brake operating sections respectively for the front and rear wheels;
wheel braking sections respectively for the front and rear wheels, each of the wheel braking sections applying a braking force to the corresponding one of the wheels according to an input from the brake operating section;
a combined braking device that activates the wheel braking section for the other wheel according to an input from the brake operating section for one of the wheels;
a slip detector that detects a state in which each of the wheels slips,
wherein, when the slip detector detects that one wheel is in a predetermined slipped state during application of a brake to the wheel, the combined braking device starts combined activation of the wheel braking section for the other wheel.

10. The vehicle according to claim 9, further comprising an antilock brake system which controls an increase or decrease in a braking force according to the slipped state of each of the wheels, wherein:
a slip detecting section for the antilock brake system is used as the slip detector; and
when the antilock brake system is activated, the combined braking device starts the combined activation of the wheel braking section for the other wheel.

11. The vehicle according to claim 9, further comprising:
an input detecting sensor which electrically detects an operation input from the brake operating section;
a braking force generator which generates a braking force according to a control command, and which feeds the braking force to the wheel braking section; and
a control that receives a vehicle state detection signal including a detection signal from the input detecting sensor, and which issues the control command to the braking force generator,
wherein the braking force generator is used to perform combined control at least on the wheel braking section for the other wheel.

12. The vehicle according to claim 10, further comprising:
an input detecting sensor which electrically detects an operation input from the brake operating section;
a braking force generator which generates a braking force according to a control command, and which feeds the braking force to the wheel braking section; and
a control that receives a vehicle state detection signal including a detection signal from the input detecting sensor, and which issues the control command to the braking force generator,
wherein the braking force generator is used to perform combined control at least on the wheel braking section for the other wheel.

13. The vehicle according to claim 9, further comprising a road surface resistance estimator that estimates a road surface resistance, wherein the combined braking device has varying braking characteristics according to an estimation result determined by the road surface resistance estimator, so that a braking force is smaller as the road surface resistance is lower.

14. The vehicle according to claim 10, further comprising a road surface resistance estimator that estimates a road surface resistance, wherein the combined braking device has varying braking characteristics according to an estimation result determined by the road surface resistance estimator, so that a braking force is smaller as the road surface resistance is lower.

15. The vehicle according to claim 11, further comprising:
a hydraulic pressure device constituted by the braking force generator;
a brake master cylinder which generates a hydraulic pressure according to an operation variable of the brake operating section;
a brake caliper assembly which applies a braking force to the wheel according to the supplied hydraulic pressure; and
a passage switching valve which selectively connects the brake caliper assembly to the brake master cylinder and the hydraulic pressure generator,
wherein during normal braking, the hydraulic pressure in the brake master cylinder is supplied to the brake caliper assembly; and during braking by the combined braking device, the hydraulic pressure in the hydraulic pressure generator is supplied to the brake caliper assembly for the other wheel.

16. The vehicle according to claim 12, further comprising:
a hydraulic pressure device constituted by the braking force generator;
a brake master cylinder which generates a hydraulic pressure according to an operation variable of the brake operating section;
a brake caliper assembly which applies a braking force to the wheel according to the supplied hydraulic pressure; and
a passage switching valve which selectively connects the brake caliper assembly to the brake master cylinder and the hydraulic pressure generator,
wherein during normal braking, the hydraulic pressure in the brake master cylinder is supplied to the brake caliper assembly; and during braking by the combined braking device, the hydraulic pressure in the hydraulic pressure generator is supplied to the brake caliper assembly for the other wheel.
